(19) United States
(12) Patent Application Publication
(10) Pub. No.: US 2023/0193621 A1
(43) Pub. Date: Jun. 22, 2023

(54) INSULATING ASSEMBLIES, METHODS OF INSTALLING INSULATION, AND RELATED INSTALLATION APPARATUSES

(71) Applicant: R-Rok Solutions, LLC, Ogden, UT (US)

(72) Inventor: Donald Doll, Ogden, UT (US)

(21) Appl. No.: 18/068,996

(22) Filed: Dec. 20, 2022

Related U.S. Application Data
(60) Provisional application No. 63/265,755, filed on Dec. 20, 2021.

(51) Int. Cl. E04B 1/78; B25B 31/00

(52) U.S. Cl. CPC E04B 1/78; B25B 31/00; E04B 2001/7691

(57) ABSTRACT

An insulating assembly includes a radiant barrier supported on a material and a magnet located on a side of the radiant barrier opposite the material to magnetically secure the radiant barrier to the material. Related methods of installing insulation and insulation installation apparatuses are also described.

### CROSS-REFERENCE TO RELATED APPLICATION

This application claims the benefit under 35 U.S.C. § 119(e) of U.S. Provisional Patent Application Ser. No. 63/265,755, filed Dec. 20, 2021, the disclosure of which is hereby incorporated herein in its entirety by this reference.

### TECHNICAL FIELD

This disclosure relates insulating assemblies. This disclosure further relates to insulating assemblies, methods of installing insulation, and apparatuses for installing insulation. More specifically, disclosed embodiments relate to insulating wall assemblies and methods of installing insulation that may better inhibit heat transfer, reduce cost, and enable easier installation.

### BACKGROUND

Thermal insulation often plays a large role in buildings because of demands for temperature controlled environments. A common way to facilitate temperature control within a building is to include thermal insulation materials in and around the frame of the building. For example, insulation against conductive and convective heat may be provided, for example, by placing foam or fiberglass in the spaces between wood or metal frame members between the outer and interior walls of a building. Radiant insulation in the form of a thin sheet of heat-reflective, metal material may also be provided, which may be accomplished by adhering a sheet of radiant insulation to surfaces of paper backing on insulation materials.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a partial-cutaway perspective view of an insulating assembly, in accordance with embodiments of this disclosure;

FIG. 2 is a side view of the insulating assembly of FIG. 1;

FIG. 3 is a side view of another insulating assembly, in accordance with embodiments of this disclosure;

FIG. 4 is a side view of an additional insulating assembly, in accordance with embodiments of this disclosure;

FIG. 5 is a side view of another insulating assembly, in accordance with embodiments of this disclosure;

FIG. 6 is a side view of an additional insulating assembly, in accordance with embodiments of this disclosure;

FIG. 7 is a side view of an additional insulating assembly, in accordance with embodiments of this disclosure;

FIG. 8 is a flowchart showing an illustrative method for installing insulation, in accordance with embodiments of this disclosure;

FIG. 9 is a side perspective view of an insulation installation apparatus in an open state, in accordance with embodiments of this disclosure;

FIG. 10 is a side view of the insulation installation apparatus of FIG. 9 in a closed state, in accordance with embodiments of this disclosure; and

FIG. 11 is a side cross-sectional view of the insulation installation apparatus of FIG. 9 in the open state, in accordance with embodiments of this disclosure.

### DETAILED DESCRIPTION

Drawings presented herein are for illustrative purposes only, and are not meant to be actual views of any particular material, component, structure, device, or system. Variations from the shapes depicted in the drawings as a result, for example, of manufacturing techniques and/or tolerances, are to be expected. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale.

Disclosed embodiments relate generally to insulating assemblies that may better inhibit heat transfer, reduce cost, and enable easier installation. More specifically, disclosed are embodiments of insulating assemblies for buildings that may include a radiant barrier supported on a material without requiring complicated and expensive formation and installation techniques. For example, magnets may be utilized to secure the radiant barrier to a building structure (e.g., to a frame) and may also be utilized to provide a gap between the radiant barrier and the building structure.

As used herein, the singular forms following “a,” “an,” and “the” are intended to include the plural forms as well, unless the context clearly indicates otherwise.

As used herein, the terms “about” in reference to a numerical value for a particular parameter, property, or condition is inclusive of the numerical value and a degree of variance from the numerical value that one of ordinary skill in the art would understand is within acceptable tolerances for the particular parameter. For example, “about” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, “and/or” includes any and all combinations of one or more of the associated listed items.

As used herein, the terms “comprising,” “including,” and grammatical equivalents thereof are inclusive or open-ended terms that do not exclude additional, un-recited elements or method steps.

As used herein, the term “configured” refers to a size, shape, material composition, and arrangement of one or more of at least one structure and at least one apparatus facilitating operation of one or more of the structure and the apparatus in a predetermined way.

As used herein, any relational term, such as “first,” “second,” etc., is used for clarity and convenience in understanding the disclosure and accompanying drawings, and does not connote or depend on any specific preference or order, except where the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, reference to a feature being “on” an additional feature includes the features being in contact with one another, as well as directly or indirectly coupled to one another, connected to one another, attached to one another, or secured to one another.

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, the terms “vertical,” and “horizontal” are in reference to a major plane of a structure and are not necessarily defined by earth's gravitational field. With reference to the figures, a “horizontal” direction may be perpendicular to an indicated “Z” axis, and may be parallel to an indicated “X” axis and/or parallel to an indicated “Y” axis; and a “vertical” direction may be parallel to an indicated “Z” axis, may be perpendicular to an indicated “X” axis, and may be perpendicular to an indicated “Y” axis.

The following description may include examples to help enable one of ordinary skill in the art to practice the disclosed embodiments. The use of the term “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

Embodiments of the present disclosure may be described in terms of a process that is depicted as a flowchart, a flow diagram, a structure diagram, or a block diagram. Although a flowchart may describe operational acts as a sequential process, many of these acts may be performed in another sequence, in parallel, or substantially concurrently. In addition, the order of the acts may be re-arranged.

As used herein, the term “magnetic” includes materials capable of exhibiting “ferromagnetism,” as well as materials capable of exhibiting “ferrimagnetism.”

As used herein, the term “ferromagnetic” in reference to a particular item means that the particular item is capable of exhibiting ferromagnetism. As non-limiting examples, ferromagnetic materials may comprise transition metals (e.g., iron (Fe), nickel (Ni), cobalt (Co), steel, and/or alloys thereof), and/or rare-earth metals (e.g., neodymium (Nd), samarium (Sm), and/or alloys thereof).

As used herein, the term “ferrimagnetic” in reference to a particular item means that the particular item is capable of exhibiting ferrimagnetism. As non-limiting examples, ferrimagnetic materials include magnetite (Fe₃O₄); yttrium iron garnet (Y₃Fe₂(FeO₄)₃, or Y₃Fe₅O₁₂); cubic ferrites comprising iron oxides (e.g., FeO, FeO₂, Fe₃O₄, etc.) with other elements such as aluminum, cobalt, nickel, manganese, and zinc; and hexagonal ferrites (e.g., PbFe₁₂O₁₉ and BaFe₁₂O₁₉) and pyrrhotite (Fe₁₋ₓS).

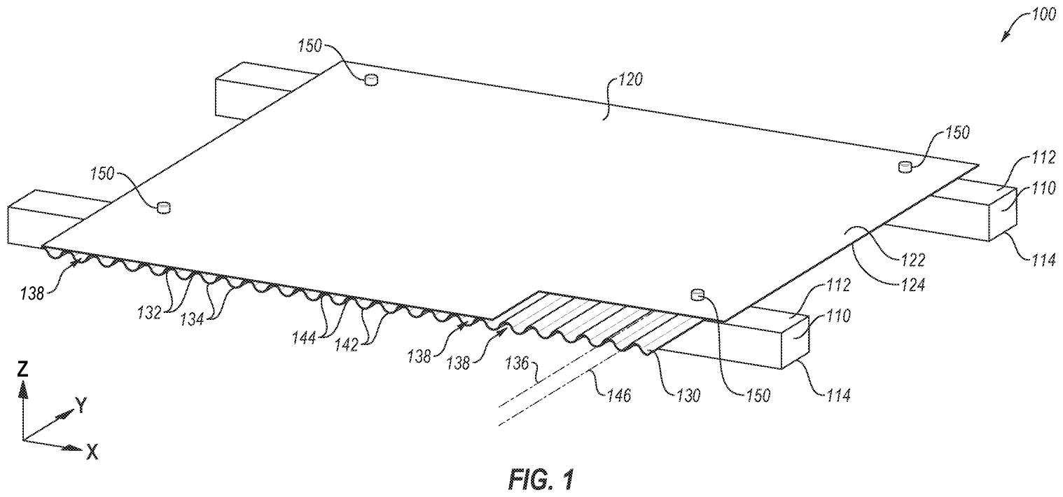

FIG. 1 is a partial-cutaway perspective view of an insulating assembly 100, in accordance with embodiments of this disclosure. The insulating assembly 100 may be used on the interior or exterior of a building, and may be positioned on any part of a building, such as the walls and/or the roof. As illustrated in FIG. 1, the insulating assembly 100 includes a material 110, a radiant barrier 120 supported on the material 110, a corrugated sheet 130 interposed between the radiant barrier 120 and the material 110, and one or more magnets 150 located on a side of the radiant barrier 120 opposite the material 110 to secure (e.g., magnetically secure) the radiant barrier 120 and the corrugated sheet 130 to the material 110. The insulating assembly 100 may provide an air gap between the material 110 and the radiant barrier 120, which may improve the thermal insulation of a structure (e.g., building) in which the insulating assembly 100 is utilized.

The material 110 may include one or more structural members of a building. For example, the material 110 may include beams, columns, posts, and/or cables used anywhere in a building frame, such as the roof and walls. In some embodiments, the material 110 includes a beam of a building frame. As illustrated in FIG. 1, the material 110 may exhibit a rectangular cross-sectional shape including a first side 112 (e.g., an interior-facing side) and a second side 114 (e.g., an exterior-facing side) opposite the first side 112. Although the cross-sectional shape of the material 110 is shown as rectangular, this disclosure is not so limited.

The material 110 may exhibit any desired shape and dimensions. For example, a cross-section of the material 110 may exhibit any desired shape (e.g., circle, triangle, square, rectangle, trapezoid, parallelogram, pentagon, hexagon, octagon, I-shape, H-shape, S-shape, C-shape, etc.). Additionally, the material 110 may be solid, hollow (e.g., tubular), channel-shaped, or beam-shaped.

The material 110 may be made of or include any materials suitable for buildings. In some embodiments, the material 110 comprises a magnetic (e.g., ferromagnetic or ferrimagnetic) material. For example, the material 110 may comprise steel structural members. In additional embodiments, the material 110 comprises a magnetic material secured to and/or within a non-magnetic (e.g., wood, concrete, stone, aluminum, etc.) structural member of a building. For example, the material 110 may comprise wood structural members with magnetic material (e.g., magnetic strips, plates, fasteners, slugs, etc.) secured to and/or embedded within the wood structural members. In further embodiments, the material 110 comprises a non-magnetic structural member of a building. For example, the material 110 may comprise wood structural members.

The insulating assembly 100 also includes a radiant barrier 120 supported on the material 110. The radiant barrier 120 may be made of or include a material configured to reflect thermal radiation, and/or inhibit heat transfer (e.g., convection and/or conduction) in at least one direction. For example, the radiant barrier 120 may inhibit the effect of thermal radiation on a first side 122 of the radiant barrier, and may also inhibit heat transfer through the radiant barrier 120 from the first side 122 to the second side 124 of the radiant barrier 120, opposite the first side 122. Additionally, the radiant barrier 120 may inhibit the effect of thermal radiation on both the first side 122 and the second side 124 of the radiant barrier 120. Furthermore, the radiant barrier 120 may inhibit heat transfer through the radiant barrier 120 in two directions (e.g., from the first side 122 to the second side 124, and from the second side 124 to the first side 122).

The radiant barrier 120 may include a reflective material and/or a thermally insulative material. For example, the radiant barrier 120 may comprise a foil material, such as a metallic foil (e.g., aluminum foil) and/or a polymer foil (e.g., biaxially-oriented polyethylene terepthalate). The foil material may include a thermally and optically reflective surface finish in some examples. In some embodiments, an entirety of the radiant barrier 120 is a reflective material (e.g., aluminum foil or polymer foil). The radiant barrier 120 may also include a composite material, such as, for example, a cloth material (e.g., wool, cotton, linen, polyester, etc.) that includes glass and/or polymer beads and/or fibers within the cloth material. Additional composite materials may include, for example, a heavy-duty polyethylene air bubble cushioning interposed between two separate foil materials, such as ASTROSHIELD® offered by Innovative Energy, Inc. of Lowell, Ind. Thus, in some embodiments, the radiant barrier 120 include a first reflective material on a first side 122 and/or a second reflective material on the second side 124 of the radiant barrier 120, and a thermally insulative material interposed between the reflective materials.

The radiant barrier 120 may exhibit any desired shape and dimensions. For example, a thickness of the radiant barrier 120, defined by the distance from the first side 122 to the second side 124 of the radiant barrier 120, may be small compared to other dimensions (e.g., length, width) of the radiant barrier 120. As non-limiting examples, the thickness of the radiant barrier 120 may be within a range of from about 0.01 mm to about 3 mm, such as from about 0.1 mm to about 1 mm, or from about 0.1 mm to about 0.5 mm (e.g., about 0.25 mm). Additionally, the length and/or the width of the radiant barrier 120 may be tailored for the size of the installation and/or to facilitate transport and installation.

The insulating assembly 100 may include a corrugated sheet 130 interposed between the material 110 and the radiant barrier 120 in some examples. The corrugated sheet 130 may include a first series of peaks 132 proximate to the radiant barrier 120 and a corresponding first series of troughs 134 located laterally between the first set of peaks 132. The first series of peaks 132 may form lines 136 of contact between the corrugated sheet 130 and the radiant barrier 120. The spaces defined between the first series of troughs 134 and the second side 124 of the radiant barrier 120 may form air gaps to provide pockets 138. The pockets 138 may facilitate more effective thermal insulation than conventional insulating assemblies.

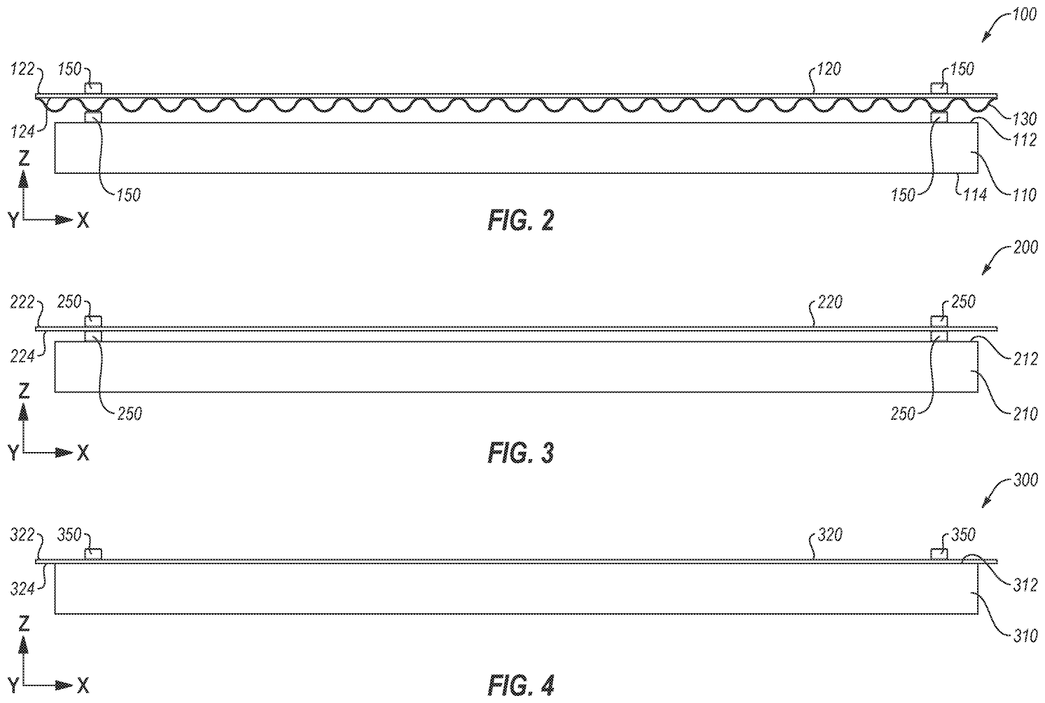

The corrugated sheet 130 may further include a second series of peaks 142 and a corresponding second series of troughs 144 located proximate to the material 110. The second series of peaks 142 may form lines 146 of contact between the corrugated sheet 130 and one or more additional magnets 150 (shown in FIG. 2 below) on the first side 112 of the material 110 or between the corrugated sheet 130 and the material 110 itself. The space defined between the second series of troughs 144 and the first side 112 of the material 110 forms one or more additional air gaps.

The corrugated sheet 130 may exhibit any desired shape and dimensions. For example, the corrugated sheet 130 may have an at least substantially sinusoidal shape when viewed in a cross-sectional plane at least substantially perpendicular to major surfaces of the radiant barrier 120 and at least substantially parallel to the material 110 (e.g., in the X-Z plane in FIG. 1). For example, a slope of the corrugated sheet 130 as the corrugated sheet 130 transitions between the first series of peaks 132 and the first series of troughs 134, and as the corrugated sheet 130 transitions between the second series of peaks 142 and the second series of troughs 144 may vary at least substantially continuously, providing a smooth, rounded, arcing wave shape at least substantially resembling a sine wave. Although illustrated as sinusoidal, the corrugated sheet 130 may include triangular and/or rectangular-shaped corrugations.

A thickness T of the corrugated sheet 130 may be measured from the lines 146 of contact between the corrugated sheet 130 and the additional magnets 150 (shown in FIG. 2 below) on the first side 112 of the material 110, to the lines 136 of contact between the corrugated sheet 130 and the second side 124 of the radiant barrier 120. The thickness T of the corrugated sheet 130, may be within a range of from about 0.5 mm to about 13 mm, such as from about 0.75 mm to about 6.5 mm, or from about 1 mm to about 5 mm (e.g., 1.6 mm).

Spacing the material 110 and the radiant barrier 120 from one another utilizing the corrugated sheet 130 and/or the additional magnets 150 (see FIG. 2) to form the pockets 138 of air between the material 110 and the radiant barrier 120, the insulating assembly 100 may further improve thermal insulation compared to directly adhering the radiant barrier 120 to the material 110. For example, the pockets 138 of air, and the barriers formed by the corrugated sheet 130, may provide additional insulation and may further inhibit heat transfer by conduction and convection.

The corrugated sheet 130 may include a directionally pliable and directionally rigid material. For example, the corrugated sheet 130 may include a lightweight material that can be shaped to include corrugations. As non-limiting examples, the corrugated sheet 130 may include a polymer-based material (e.g., polypropylene, polycarbonate, acrylic, etc.), and/or a paper-based material (e.g., a cardboard). In some embodiments, the corrugated sheet 130 may include the type and shape of cardboard employed between panels of planar cardboard material for cardboard shipping boxes.

The insulating assembly 100 additionally includes the magnets 150. The magnets 150 may be located on the first side of the radiant barrier 120 opposite the material 110. The magnets 150 may secure (e.g., magnetically secure) the radiant barrier 120 to the material 110.

The magnets 150 may include a ferromagnetic material (e.g., neodymium, samarium) in some examples. Additionally, the magnets 150 may exhibit small dimensions to facilitate installation and removal of the insulating assembly 100. For example, the magnets 150 may exhibit a diameter within a range of from about 1 mm to about 26 mm, such as from about 1.5 mm to about 20 mm, from about 2 mm to about 15 mm, from about 3 mm to about 13 mm, from about 4 mm to about 10 mm (e.g., about 6.5 mm).

In some embodiments the insulating assembly 100 may include a single magnet 150 on a first side 122 of the radiant barrier 120 opposite the material 110. In additional embodiments, the insulating assembly 100 may include a first series of magnets 150 on the first side 122 of the radiant barrier 120 opposite the material 110. Although illustrated in FIG. 1 as four magnets 150, the magnets 150 may include any number of magnets 150.

FIG. 2 is a side view of the insulating assembly 100 of FIG. 1. For simplicity, FIGS. 2 through 7 illustrate side views of insulating assemblies described herein showing the material (e.g., the material 110, 210, 310, 410, 510, and 610) in a horizontal position. In application, the insulating assemblies 100, 200, 300, 400, 500, 600 may be oriented in a manner corresponding to the orientation of the frame of a building. As non-limiting examples, the insulating assemblies shown in FIGS. 2 through 7 may be rotated 90°, 180°, or 270° from the orientation illustrated therein.

Referring now to FIG. 2, the insulating assembly 100 may include one or more additional magnets 150 interposed between the second side 124 of the radiant barrier 120 and the first side 112 of the material 110. In some embodiments, the insulating assembly 100 includes an additional magnet 150 interposed between the radiant barrier 120 and the material 110, such that an air gap is located between the radiant barrier 120 and the material 110, and the radiant barrier 120 is interposed between the magnet 150 and the additional magnet 150. In additional embodiments, the insulating assembly 100 includes additional magnets 150 interposed between the second side 124 of the radiant barrier 120 and the first side 112 of the material 110. The material 110 may include a magnetic material, and the additional magnets 150 may be secured (e.g., magnetically) to the material 110. The additional magnets 150 may be located at the same positions (e.g., in the X-direction and Y-direction) as, and be at least substantially aligned with, the magnets 150 on the first side 122 of the radiant barrier 120, such that the magnets 150 and the additional magnets 150 may be attracted to one another through the radiant barrier 120 and the corrugated sheet 130 utilizing magnetic fields.

The magnetic field between the magnets 150 and the additional magnets 150 may secure the radiant barrier 120 and the corrugated sheet 130 to the material 110. For example, the material 110 may include a magnetic material to which the additional magnets 150 are secured by magnetic attraction.

Insulating assemblies described herein (e.g., the insulating assembly 100) may include a variety of materials and may be assembled in a variety of ways, as shown in FIGS. 3 through 7. FIGS. 3 through 7 illustrate side views of insulating assemblies, in accordance with additional embodiments of this disclosure. In FIGS. 3 through 7 and the associated description, functionally similar features (e.g., structures, materials) as those described above with reference to FIGS. 1 and 2 are referred to with similar reference numerals incremented by 100, 200, 300, 400, and 500 respectively. To avoid repetition, not all features shown in any of FIGS. 3 through 7 are described in detail herein. Rather, unless described otherwise below, a feature in any of FIGS. 3 through 7 designated by a reference numeral that is a 100, 200, 300, 400, or 500 increment of the reference numeral of a previously described feature will be understood to be at least substantially similar to the previously described feature.

FIG. 3 illustrates a side view of another insulating assembly 200, in accordance with embodiments of the disclosure. Referring now to FIG. 3, the insulating assembly 200 may include a material 210, a radiant barrier 220 supported on the material 210, and magnets 250 located on a first side 222 of the radiant barrier to secure (e.g., magnetically secure) the radiant barrier 220 to the material 210.

The insulating assembly 200 may also include additional magnets 250 interposed between the second side 224 of the radiant barrier 220 and the first side 212 of the material 210. The additional magnets 250 may be on the second side 224 of the radiant barrier 220 and supported on the material 210. The material 210 shown in FIG. 3 may include a magnetic material, and the additional magnets 250 may be secured to the material 210 by magnetic attraction. The additional magnets 250 may be located at the same positions (e.g., in the X-direction and Y-direction) as, and may be at least substantially aligned with, the magnets 250 on the first side 222 of the radiant barrier 220, such that the magnets 250 and the additional magnets 250 may be attracted to one another through the radiant barrier 220 utilizing magnetic fields.

In some embodiments, the radiant barrier 220 may include a non-magnetic material and the magnetic attraction between the magnets 250 and the additional magnets 250 through the radiant barrier 220 may secure the radiant barrier 220 to the material 210. In additional embodiments, the radiant barrier may include a magnetic material and the additional magnets 250 may be secured (e.g., magnetically) to the second side 224 of the radiant barrier 220. The magnets 250 may be secured (e.g., magnetically) to the first side 222 of the radiant barrier 220, and indirectly secured to the additional magnets 250 due to the magnetic attraction between the magnets 250 and the additional magnets 250. Furthermore, the location and thickness of the additional magnets 250 may form an air gap between the second side 224 of the radiant barrier 220 and the first side 212 of the material 210. The air gap between the radiant barrier 220 and the material 210 may provide additional insulation and may further inhibit heat transfer by conduction and convection. As shown in FIG. 3, the radiant barrier 220 may lack any corrugated sheets 130 (see FIG. 1), such that only the additional magnets 150 may be interposed between the radiant barrier 220 and the material 210.

FIG. 4 illustrates a side view an additional insulating assembly 300, in accordance with embodiments of the disclosure. Referring now to FIG. 4, the insulating assembly 300 may include a material 310, a radiant barrier 320 supported on the material 310, and magnets 350 located on a first side 322 of the radiant barrier to secure (e.g., magnetically secure) the radiant barrier 320 to the material 310 such that the second side 324 of the radiant barrier 320 is in contact with the first side 312 of the material 310. The material 310 shown in FIG. 4 may include a magnetic material.

In some embodiments, the radiant barrier 320 may include a non-magnetic material and the magnetic attraction between the magnets 350 and the material 310 through the radiant barrier 320 may secure the radiant barrier 320 to the material 310. In additional embodiments, the radiant barrier may include a magnetic material and the magnets 350 may be secured (e.g., magnetically) to the first side 322 of the radiant barrier 320, and indirectly secured to the material 310 due to the magnetic attraction between the magnets 350 and the material 310.

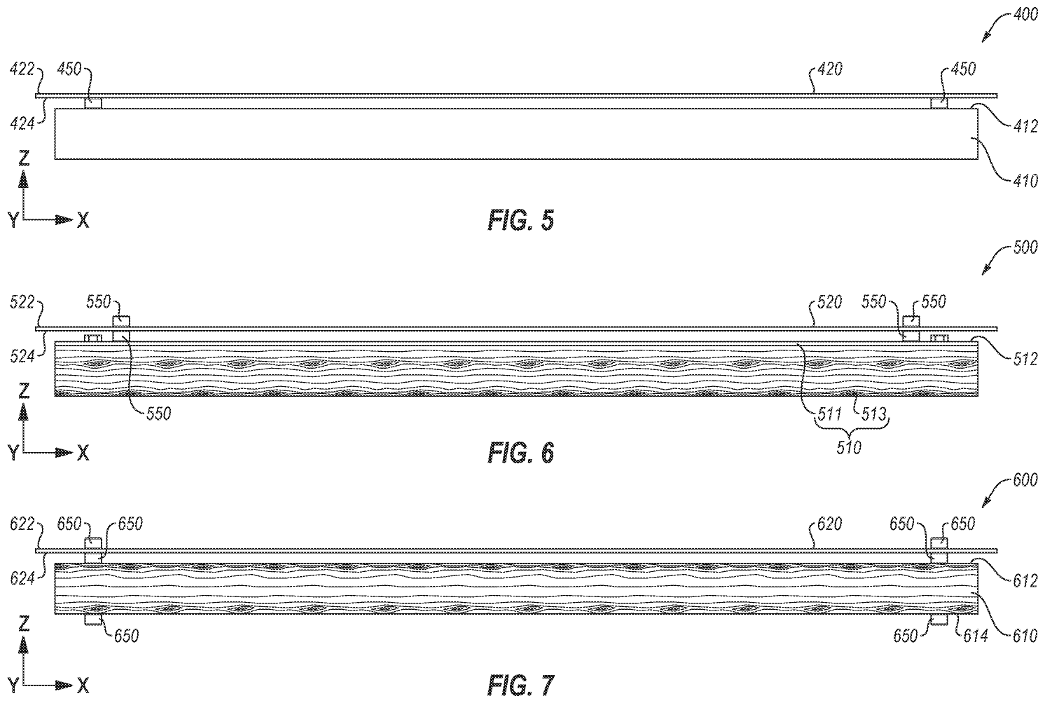

FIG. 5 illustrates a side view of another insulating assembly 400, in accordance with embodiments of this disclosure. Referring now to FIG. 5, the insulating assembly 400 may include a material 410, a radiant barrier 420 supported on the material 410, and magnets 450 interposed between the radiant barrier 420 and the material 410 to secure the radiant barrier 420 to the material 410. The first side 422 of the radiant barrier 420 may be free of any of the magnets 450. The magnets 450 may be on a second side 424 of the radiant barrier 420 and supported on the material 410. The material 410 and the radiant barrier 420 shown in FIG. 5 may each include magnetic material.

The magnets 450 may be secured (e.g., magnetically) to the first side 412 of the material 410 and also secured (e.g., magnetically) to the second side 424 of the radiant barrier 420. The location and thickness of the magnets 450 may form an air gap between the second side 424 of the radiant barrier 420 and the first side 412 of the material 410. The air gap between the radiant barrier 420 and the material 410 may provide additional insulation and may further inhibit heat transfer by conduction and convection.

FIG. 6 illustrates a side view of an additional insulating assembly 500, in accordance with embodiments of this disclosure. Referring now to FIG. 6, the insulating assembly 500 may include a material 510, a radiant barrier 520 supported on the material 510, and magnets 550 located on a first side 522 of the radiant barrier 520 to secure (e.g., magnetically secure) the radiant barrier 520 to the material 510. The insulating assembly 500 may also include additional magnets 550 interposed between the material 510 and the radiant barrier 520. The additional magnets 550 may be on the second side 524 of the radiant barrier 520 and supported on the material 510.

The material 510 may include a first member of a non-magnetic material 511 (e.g., wood, concrete, stone, aluminum, etc.) and a second member of a magnetic material 513 secured to the non-magnetic material 511. For example, the material 510 may be a wooden structural member with a strip or plate of steel secured to the wooden structural member. The magnetic material 513 may be on the first side 512 of the material 510. Although FIG. 6 illustrates the magnetic material 513 as a strip or a plate, the magnetic material 513 may also include fasteners (e.g., pins, nails, screws, bolts, etc.) and/or slugs of magnetic material secured to and/or embedded within the non-magnetic material 511. The magnetic material 513 may be adhered and/or fastened to the non-magnetic material 511. For example, the magnetic material 513 may be secured to the non-magnetic material 511 using screws, bolts, pins, nails, etc., as shown in FIG. 6.

In some embodiments, the radiant barrier 520 may include a non-magnetic material and the magnetic attraction between the magnets 550 and the additional magnets 550 through the radiant barrier 520 may secure the radiant barrier 520 to the material 510. In additional embodiments, the radiant barrier may include a magnetic material and the additional magnets 550 may be secured (e.g., magnetically) to the second side 524 of the radiant barrier 520. The magnets 550 may be secured (e.g., magnetically) to the first side 522 of the radiant barrier 520, and indirectly secured to the additional magnets 550 due to the magnetic attraction between the magnets 550 and the additional magnets 550. Furthermore, the location and thickness of the additional magnets 550 may form an air gap between the second side 524 of the radiant barrier 520 and the first side 512 of the material 510. The air gap between the radiant barrier 520 and the material 510 may provide additional insulation and may further inhibit heat transfer by conduction and convection.

FIG. 7 illustrates a side view of an additional insulating assembly 600, in accordance with embodiments of this disclosure. Referring now to FIG. 7, the insulating assembly 600 may include a material 610, a radiant barrier 620 supported on the material 610, and magnets 650 located on a first side 622 of the radiant barrier 620 to secure (e.g., magnetically secure) the radiant barrier 620 to the material 610. The insulating assembly 600 may include additional magnets 650 interposed between the material 610 and the radiant barrier 620. The additional magnets 650 may be on the second side 624 of the radiant barrier 620 and supported on the material 610. The material 610 shown in FIG. 7 may include a non-magnetic material.

Because the material 610 may include a non-magnetic material, the insulating assembly 600 may include further magnets 650 on a side of the material 610 opposite the radiant barrier 620. The further magnets 650 may be on a second side 614 of the material 610 opposite the first side 612. The further magnets 650 and the additional magnets 650 may be magnetically attracted to one another through the material 610 with sufficient force to support one another and the radiant barrier 620 in position.

In some embodiments, the radiant barrier 620 may include a non-magnetic material and magnetic attraction between the magnets 650 and the additional magnets 650 through the radiant barrier 620 may secure the magnets 650 to the additional magnets 650. Additionally, the magnetic attraction between the additional magnets 650 and the further magnets 650 may secure the radiant barrier 620 to the material 610. In additional embodiments, the radiant barrier may include a magnetic material and the additional magnets 650 may be secured (e.g., magnetically) to the second side 624 of the radiant barrier 620. The magnets 650 may be secured (e.g., magnetically) to the first side 622 of the radiant barrier 620, and indirectly secured to the additional magnets 650 due to the magnetic attraction between the magnets 650 and the additional magnets 650. Furthermore, the location and thickness of the additional magnets 650 may form an air gap between the second side 624 of the radiant barrier 620 and the first side 612 of the material 610. The air gap between the radiant barrier 620 and the material 610 may provide additional insulation and may further inhibit heat transfer by conduction and convection.

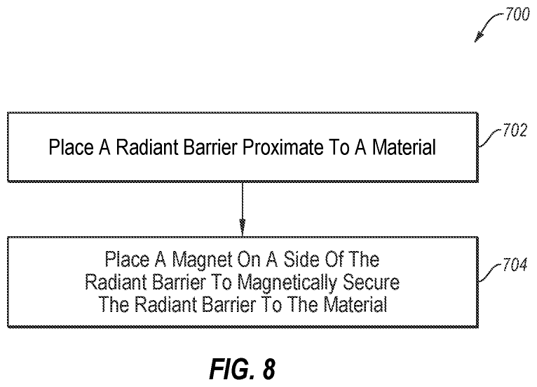

The insulating assemblies 100, 200, 300, 400, 500, 600 described herein may take a variety of forms and be installed in a variety of ways. FIG. 8 is a flow chart showing an illustrative method for installing insulation (e.g., the insulating assemblies 100, 200, 300, 400, 500, 600), in accordance with embodiments of this disclosure.

Referring now to FIG. 8, a method of installing insulation 700 may involve placing a radiant barrier proximate to a material, as shown in act 702. For example, placing the radiant barrier proximate the material may involve placing a corrugated sheet secured to the radiant barrier only along a series of peaks of the corrugated sheet proximate to the material. The corrugated sheet may be placed adjacent the radiant barrier and interposed between magnets. Additionally, placing the radiant barrier proximate to the material may include placing the radiant barrier proximate to a magnetic material. For example, the radiant barrier may be placed proximate to a magnetic strip, magnetic plates, magnetic fasteners, and/or magnetic slugs secured to a beam of a building frame.

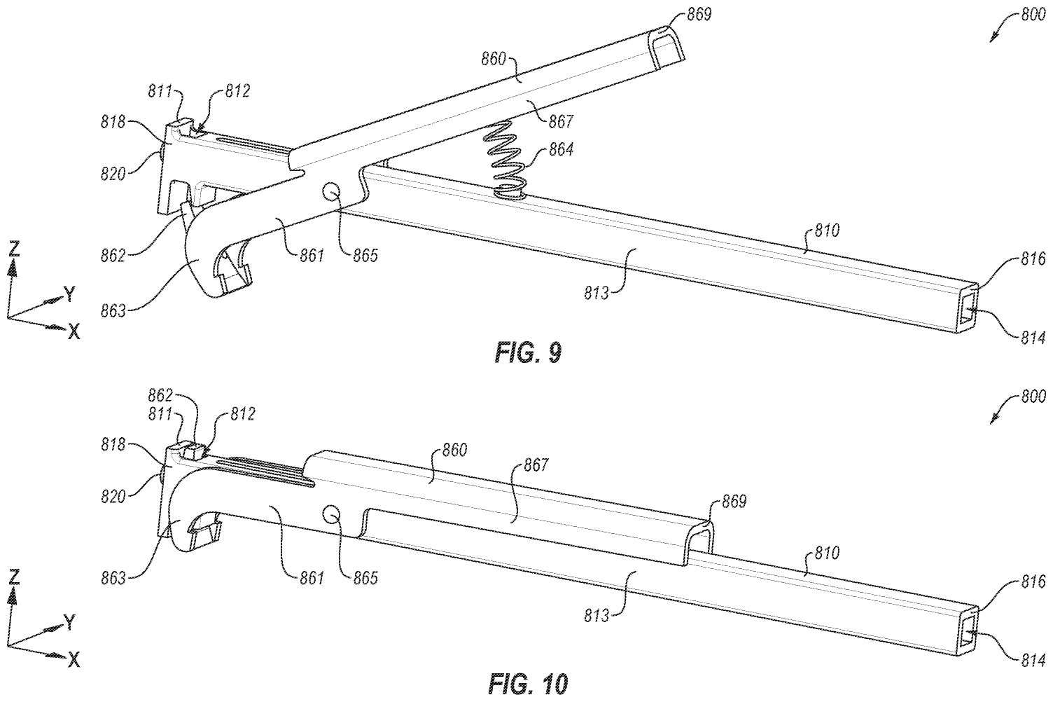

The method of installing insulation 700 may also involve placing a magnet on a side of the radiant barrier to magnetically secure the radiant barrier to the material, as shown in act 704. For example, placing the magnet on the side of the radiant barrier may involve dispensing the magnet from within a non-magnetic magazine of a panel installation apparatus (see FIGS. 9 through 11 below).

The method of installing insulation 700 may additionally involve placing an additional magnet on another side of the radiant barrier. The other side of the radiant barrier may be between the radiant barrier and the material such that an air gap is located between the radiant barrier and the material. Additionally, the radiant barrier may be interposed between the magnet and the additional magnet.

The method of installing insulation 700 may further include placing a corrugated sheet between the material and the radiant barrier.

To facilitate installing insulation as described with reference to FIG. 8, an insulation installation apparatus may be utilized for placing the magnets. FIGS. 9 through 11 show an insulation installation apparatus 800 that may be utilized to install insulation in accordance embodiments of this disclosure. For example, the insulation installation apparatus 800 may be used in accordance with the method of FIG. 8 to install any of the insulation assemblies of FIGS. 1 through 7.

Referring collectively to FIGS. 9 through 10, the insulation installation apparatus 800 may be configured to move between an open position (FIG. 9) and a closed position (FIG. 10). Movement of the insulation installation apparatus 800 between the open position and the closed position may result in relative movement between parts of the insulation installation apparatus 800 and may remove (e.g., eject, dispense) an item (e.g., a magnet) from within the insulation installation apparatus 800. In operation, a stack of magnets (e.g., a stack of the magnets 150, 250, 350, 450, 550, 650) may be within and attracted to (e.g., magnetically attracted) and/or secured to one end of the insulation installation apparatus 800 and a single magnet at an end of a stack of magnets may be removed from within the insulation installation apparatus 800 responsive to transitioning of the insulation installation apparatus 800 from the open position to the closed position and back to the open position.

Referring now to FIG. 9, the insulation installation apparatus 800 is depicted in the open position. The insulation installation apparatus 800 may include a magazine 810 and an actuator 860 connected to the magazine 810. For example, the magazine 810 may be secured to the actuator 860 via a fastener (e.g., pin, bolt, screw, nail) at a securing point 865. The actuator 860 may be configured to move relative to the magazine 810 such that the insulation installation apparatus 800 is configured to transition between the open position and the closed position. For example, the actuator 860 may be configured to rotate relative to the magazine 810 to transition between the open position and the closed position.

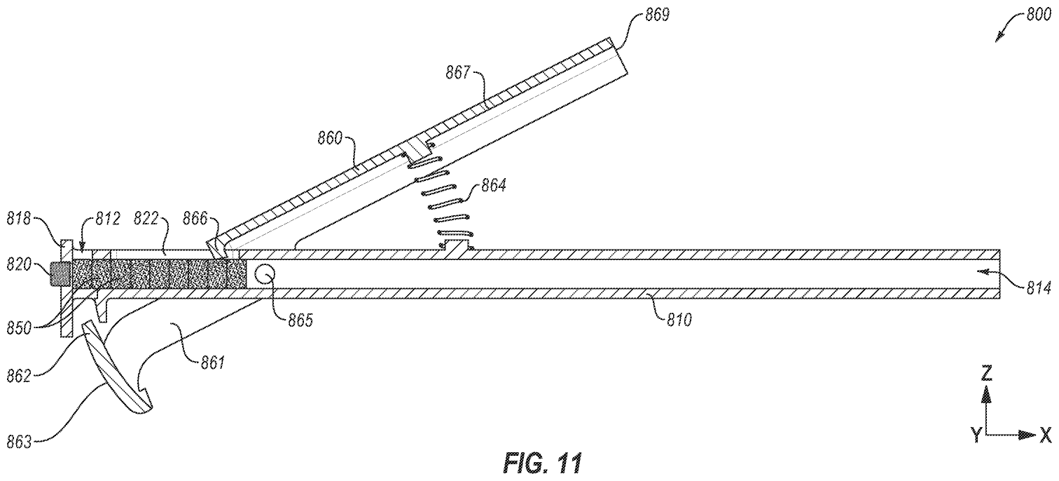

The magazine 810 may be configured to receive a stack of the magnets 850 (see FIG. 11) within an interior of the magazine 810. The magazine 810 may include a first portion 811 (e.g., an end portion), and a second portion 813 extending longitudinally (e.g., in the X-direction depicted in FIGS. 9 through 11) away from the first portion 811. In some embodiments, the first portion 811 may include a magnetic material and the second portion 813 may include a non-magnetic material.

The magazine 810 may additionally include a slot 812 proximate to an end of the magazine 810. For example, the slot may be proximate to the first portion 811 of the magazine 810. The slot 812 may be sized for one magnet 850 of the stack of the magnets 850 within the magazine 810 to pass through the slot 812 at a time. For example, the slot 812 may be used to load magnets one-by-one into the magazine 810 and/or may be used to unload magnets one-by-one from the magazine 810. More specifically, a thickness of the slot 812 may be between about 1.1 and 1.5 times a corresponding average thickness of the magnets 850, as measured in the X-direction, as shown in FIG. 9 through 11.

In some embodiments, the magazine 810 may include a generally tubular structure defining a central opening 814 extending from a first end 816 of the magazine 810 and terminating at a second end 818 of the magazine 810 opposite the first end 816. The central opening 814 may be sized, shaped, positioned, and configured to receive a stack of the magnets 850 through the first end 816. The magazine 810 may also include an end magnet 820 on the second end 818 of the magazine 810. The end magnet 820 may be configured to support the stack of the magnets 850 within the central opening 814 of the magazine 810, and to attract the stack of the magnets 850 toward the second end 818. The slot 812 may extend through the tubular structure proximate the second end 818 of the magazine 810 and proximate the end magnet 820. The slot 812 may extend through the magazine 810 proximate the second end 818 of the magazine 810 and proximate the end magnet 820.

FIG. 10 illustrates the insulation installation apparatus 800 of FIG. 9 in the closed position. Referring now to FIG. 10, the actuator 860 may be connected to the magazine such that the actuator 860 is configured to contact and push a single magnet of the stack of the magnets 850 through the slot 812 of the magazine 810 to an exterior of the magazine 810 in response to movement of the actuator 860.

Referring collectively to FIGS. 9 and 10, in some embodiments, the actuator 860 may include a lever secured to the magazine 810 and configured to rotate relative to the magazine 810 between the open position and the closed position. The actuator 860 may include a first portion 861 extending from a first end 863 to the securing point 865, and a second portion 867 extending from the securing point 865 to a second end 869 of the actuator 860. The actuator 860 may include an head 862 (e.g., a protrusion, extension) configured to be received within the slot 812 of the magazine 810 in the closed position such that the aperture displaces a single magnet of the stack of the magnets 850. The head 862 of the actuator 860 may be configured to contact a single magnet from within the magazine 810. In some embodiments, the head 862 of the actuator 860 may include a magnetic material to facilitate removing (e.g., ejecting, dispensing) a single magnet from the stack of the magnets 850.

The actuator 860 may additionally include a biasing element 864 (e.g., a spring) secured to the actuator 860 and the magazine 810. The biasing element 864 may bias the insulation installation apparatus 800 toward the open position to facilitate using the insulation installation apparatus 800. For example, each transition from the open position to the closed position may remove a magnet from the stack of the magnets 850 within the magazine 810.

FIG. 11 illustrates a side-cross-sectional view of the insulation installation apparatus 800 of FIGS. 9 and 10. Referring now to FIG. 11, the insulation installation apparatus 800 includes a stack of the magnets 850 within the central opening 814. As can be seen in FIG. 11, the actuator 860 may include an aperture 866 that may be received within a track 822 of the magazine 810.

In operation, the stack of the magnets 850 may be attracted to and/or secured to the second end 818 of the magazine 810. For example, the stack of the magnets 850 within the magazine 810 may be magnetically secured to the end magnet 820 such that the weight of the stack of the magnets 850 may be suspended by the end magnet 820. Additionally, the magnetic attraction between the stack of the magnets 850 and the end magnet 820 may align a magnet 850 at the top of the stack of the magnets 850 with the slot 812, as shown. The biasing element 864 biases the actuator 860 such that the insulation installation apparatus 800 is biased toward the open position. As a user (e.g., a person) presses the second portion 867 of the actuator 860 toward the magazine 810, the actuator 860 rotates about the securing point 865 toward the closed position. As the actuator 860 rotates toward the closed position, the head 862 is received within the slot 812 of the magazine 810 and contacts a single magnet 850 within the stack of the magnets 850. The head 862 of the actuator 860 continues to rotate through the slot 812 of the magazine 810 such that the single magnet 850 is removed (e.g., ejected, dispensed) from the interior of the magazine 810 to an exterior of the magazine 810. As the actuator 860 rotates back to the open position, the remaining stack of the magnets 850 may move toward the end magnet 820 of the magazine 810 responsive to magnetic attraction to the end magnet 820, positioning a next magnet 850 in the stack for removal (e.g., ejection, dispensation) from the insulation installation apparatus 800. The magnets 850 may be individually placed on a material (e.g., the material 110, 210, 310, 410, 510, 610) and/or a radiant barrier (e.g., the radiant barrier 120, 220, 320, 420, 520, 620) at desired locations to install insulation (e.g., form any of the insulating assemblies of FIGS. 1 through 7).

Although illustrated as a mechanical actuator, the actuator 860 may include any actuator capable of moving an item (e.g., a magnet) relative to the magazine 810. For example, the actuator may include electrical, pneumatic, and/or additional mechanical actuators.

Embodiments of insulating assemblies, methods of installing insulation, and insulation installation apparatuses in accordance with this disclosure may facilitate the installation of insulation and may provide improved thermal insulation compared to conventional assemblies. For example, gaps and/or air pockets formed between the radiant barrier and the material to which the radiant barrier may dramatically reduce thermal radiation, convection, and/or conduction.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternative useful combinations of the elements described, will become apparent to those skilled in the art from the description. Such modifications and embodiments also fall within the scope of the appended claims and equivalents.

What is claimed is:

1. An insulating assembly, comprising:
a radiant barrier supported on a material; and
a magnet located on a side of the radiant barrier opposite the material to magnetically secure the radiant barrier to the material.

2. The insulating assembly of claim 1, comprising an additional magnet between the radiant barrier and the material, the additional magnet interposed between the radiant barrier and the material, such that an air gap is located between the radiant barrier and the material and the radiant barrier is interposed between the magnet and the additional magnet.

3. The insulating assembly of claim 2, wherein the radiant barrier is secured between a series of magnets including the magnet on the side of the radiant barrier opposite the material and another series of magnets including the additional magnet interposed between the radiant barrier and the material.

4. The insulating assembly of claim 2, further comprising a corrugated sheet secured to the radiant barrier only along a series of peaks of the corrugated sheet, the corrugated sheet interposed between the magnet and the additional magnet with the radiant barrier.

5. The insulating assembly of claim 4, wherein the corrugated sheet is interposed between the material and the radiant barrier.

6. The insulating assembly of claim 1, wherein the material comprises a magnetic material.

7. The insulating assembly of claim 6, wherein the magnetic material comprises a magnetic beam of a building frame or a strip of the magnetic material secured to a non-magnetic structural member of a building frame.

8. A method of installing insulation, the method comprising:
placing a radiant barrier proximate to a material; and
placing a magnet on a side of the radiant barrier opposite the material to magnetically secure the radiant barrier to the material.

9. The method of claim 8, further comprising placing an additional magnet between the radiant barrier and the material, such that an air gap is located between the radiant barrier and the material, and the radiant barrier is interposed between the magnet and the additional magnet.

10. The method of claim 9, further comprising securing the radiant barrier secured between a series of magnets including the magnet on the side of the radiant barrier opposite the material and another series of magnets including the additional magnet interposed between the radiant barrier and the material.

11. The method of claim 9, wherein placing the radiant barrier proximate to the material comprises placing a corrugated sheet secured to the radiant barrier only along a series of peaks of the corrugated sheet proximate to the material, the corrugated sheet interposed between the magnet and the additional magnet with the radiant barrier.

12. The method of claim 11, further comprising placing the corrugated sheet between the material and the radiant barrier.

13. The method of claim 8, wherein placing the radiant barrier proximate to the material comprises placing the radiant barrier proximate to a magnetic material.

14. The method of claim 13, wherein placing the radiant barrier proximate to the magnetic material comprises placing the radiant barrier proximate to a strip or plate of the magnetic material secured to a non-magnetic structural member of a building frame.

15. The method of claim 8, wherein placing the magnet on the side of the radiant barrier comprises dispensing the magnet from within a non-magnetic magazine of a panel installation apparatus.

16. An insulation installation apparatus, comprising:
a magazine configured to receive a stack of magnets within an interior of the magazine, the magazine comprising a slot sized for one magnet of the stack of the magnets to pass through the slot at a time; and
an actuator connected to the magazine and configured to move relative to the magazine such that the actuator contacts and pushes a single magnet of the stack of the magnets through the slot to an exterior of the magazine responsive to movement of the actuator.

17. The insulation installation apparatus of claim 16, wherein a first portion of the magazine proximate the slot comprises a magnetic material and a second portion of the magazine extending longitudinally away from the first portion of the magazine comprises a non-magnetic material.

18. The insulation installation apparatus of claim 16, wherein an aperture of the actuator positioned and configured to contact the single magnet comprises a magnetic material.

19. The insulation installation apparatus of claim 16, wherein the magazine comprises:
a tubular structure defining a central opening extending from a first end of the tubular structure and terminating at a second end of the tubular structure opposite the first end, the central opening configured to receive the stack of the magnets through the first end; and
an end magnet secured to the second end of the tubular structure and configured to support the stack of the magnets,
wherein the slot extends through the tubular structure proximate the second end of the tubular structure.

20. The insulation installation apparatus of claim 16, wherein the actuator comprises:
a lever secured to the magazine and configured to rotate relative to the magazine between an open position and a closed position, the lever comprising an aperture proximate a first end of the lever, the aperture configured to be received within the slot in the closed position such that the aperture displaces the single magnet of the stack of the magnets; and
a biasing element connecting the lever to the magazine, the biasing element configured to bias the lever toward the open position.
